(19) United States
(12) Patent Application Publication
(10) Pub. No.: US 2010/0240298 A1
(43) Pub. Date: Sep. 23, 2010

(54) COMMUNICATION NETWORK FOR A MULTI-MEDIA MANAGEMENT SYSTEM WITH END USER FEEDBACK

(75) Inventors: Daniel Bernard McKenna, Vail, CO (US); James Michael Graziano, Hotchkiss, CO (US)

Correspondence Address: PATTON BOGGS LLP, 1801 CALFORNIA STREET, SUITE 4900, DENVER, CO, 80202, US

(73) Assignee: Lava Two, LLC, Vail, CO (US)

(21) Appl. No.: 12/675,363

(22) PCT Filed: Aug. 31, 2007
(86) PCT No.: PCT/US2007/077409

§ 371 Date: Feb. 25, 2010

(51) Int. Cl. H04H 20/71

(52) U.S. Cl. 455/3.05

(57) ABSTRACT

The Network For Multi-Media Management enables a reverse path feedback architecture wherein the forward path multicasted content can be dynamically modified as a result of end user interaction or feedback. End users in the Network For Multi-Media Management are grouped via location or region, together with personal attributes such as demographic, socio-graphic, or psychographic interests as it relates to a given multicasted content stream. The pairing of physical location groupings with personal interest attributes enables new and novel telecommunication services with the attendant advantage of extremely efficient delivery. The wireless communication network's capacity utilization, both in terms of assets and spectrum, is very high.

### CROSS-REFERENCE TO RELATED APPLICATIONS

This application is a national stage of PCT Patent Application No. PCT/US07/077409 filed Aug. 31, 2007, and is hereby incorporated by reference to the same extent as though fully disclosed herein. This application also is related to applications titled “Transaction Management System In A Multicast Or Broadcast Wireless Communication Network” filed concurrently herewith; “Forward Path Multi-Media Management System With End User Feedback To Central Content Sources” filed concurrently herewith; “Forward Path Multi-Media Management System With End User Feedback To Distributed Content Sources” filed concurrently herewith; “Gaming System With End User Feedback For A Communication Network Having A Multi-Media Management” filed concurrently herewith; “Gaming Device For Multi-Player Games” filed concurrently herewith; and “Virtual Aggregation Processor For Incorporating Reverse Path Feedback Into Content Delivered On A Forward Path”, filed concurrently herewith.

### FIELD OF THE INVENTION

This invention relates to multicast wireless communication networks that enable feedback via the reverse path (end user device to network direction) from at least one of a plurality of end users who are capable of influencing, modifying, or changing the delivered forward path content (network to end user device direction) being delivered via a wireless multicast communication network.

### BACKGROUND OF THE INVENTION

A feature of multicast service in a wireless communication network is that multiple end users share a single wireless air interface channel, logical or physical, which extends from the base station radio transmitter in the wireless communication network to their wireless end user devices, which single wireless air interface channel comprises the forward path that carries the multicast multi-media content. A plurality of end user devices thereby concurrently receives the multi-media content on the same channel. However, this delivered multi-media content, information, or data (collectively termed “content” or “multi-media content” herein) is static and is simply a replica of the source content, less any transmission or coding errors. The wirelessly multicast source content is immutable and does not have end user interaction or feedback.

New wireless multi-media content delivery architectures, such as MediaFLO (“Media ForwardLinkOnly”)and VB-H(Digital Video Broadcast-Handheld), function by using a broadcast architecture in the forward path to produce a pseudo-multicast delivery and concurrently disseminate multi-media content to a plurality of wireless end user devices on a single air interface channel. In these architectures (also termed “multicast” herein), a unidirectional multi-media wireless broadcast network transmits multi-media content to selected authorized wireless end user devices in a time concurrent fashion. However, there is no interconnection, interaction, or feedback between the end users and their associated end user devices with this multicasted multi-media content stream. The forward path content is completely and totally static in its nature. The delivered multi-media content is essentially no different than UHF or VHF broadcasted television, other than it can be received on small portable digital devices.

The MediaFLO and DVB-H multi-media wireless architectures, therefore, are static in their user interface, since there is no interactivity or feedback between delivered multi-media content and the end user. The multicasted content is invariant or immutable in its extent. That is, whatever is delivered to the wireless network for transmission to the end user population is delivered as an exact replica, untouched and unmodified from its original form. This is a distinct and inherent limitation of the present wireless multicasting art (even though multicasting is efficient and targeted).

The present wireless multicasting art does not enable or permit end users, via their associated end user devices, to modify the multi-media content carried on the forward path in any manner. Still, there are numerous applications wherein the ability to modify the forward path multicast content based on end user (subscriber) input or actions would be highly desired. What is needed is a novel adaptation of a wireless multicast network that enables end user interaction and modification of the forward path delivered multi-media content.

In this new architecture, the end user population would have an unprecedented ability to communicate data and knowledge via the reverse path, a capability heretofore unavailable. The scope and diversity of these end user driven applications, while virtually unlimited, include: multiplayer gaming, emergency events, education, medicine, live sporting events, automobile traffic congestion reports, and the like. This interactivity could be embodied in numerous forms to include, but not be limited to: opinion polling, purchase processing, public safety, social networking, or any other instance where it would be useful to have the content being delivered on the forward path modified based on end user feedback or interaction.

Thus, the state of the wireless multicasting art does not enable the capability to dynamically modify the content delivered on the forward path via aggregated feedback or input from at least one of a plurality of end users via their associated end user devices. No system heretofore has envisioned engaging the end user to directly and actively influence the delivered multicasted content.

### BRIEF SUMMARY OF THE INVENTION

The above-described problems are solved and a technical advance is realized over the present wireless multicasting art with the present Communication Network For A Forward Path Multi-Media Management System (termed “Network For Multi-Media Management” herein), which enables a reverse path feedback architecture wherein the forward path multicasted content can be dynamically modified as a result of end user interaction or feedback. End users in the Network For Multi-Media Management are grouped via location or region, together with personal attributes such as demographic, socio-graphic, or psychographic interests as it relates to a given multicasted content stream. The pairing of physical location groupings with personal interest attributes enables new and novel telecommunication services with the attendant advantage of extremely efficient delivery. The wireless communication network's capacity utilization, both in terms of assets and spectrum, is very high.

In this Network For Multi-Media Management architecture, end user devices share a common wireless forward path of a multicast communication architecture in which the forward path delivered content is dynamically changed or modified based on a real-time, near-real-time, or delay-time basis via aggregated reverse path feedback from at least one of a plurality of end user devices. The Forward Path Multi-Media Management System periodically or continuously aggregates the feedback input received via the reverse path (having wired and/or wireless connectivity) of the Network For Multi-Media Management, modifies the forward path multi-media content, and delivers this dynamically modified multi-media content to the then connected population of end user devices via a wireless forward path multicast in the Network for Multi-Media Management in a repetitive closed loop fashion.

The Forward Path Multi-Media Management System aggregates the reverse path feedback from the end user device or devices and then processes this feedback data in context with the streamed forward path content. For example, if the application is a multiplayer game, the Forward Path Multi-Media Management System receives the end user's reverse path feedback data which defines how their avatar or in-game virtual person should react or behave at a given point within the game. This feedback is sent to the Forward Path Multi-Media Management System via wired or wireless means from the Network For Multi-Media Management. The Forward Path Multi-Media Management System, in this gaming example, aggregates and delivers the “combined feedback” of all the connected end users for that moment in time to the gaming software application. The gaming software application then modifies its streamed forward path content according to the latest “combined feedback”. The Network For Multi-Media Management then delivers the latest video frames or sequence of successive game image frames of the game session (to include sound) to the participating end users based on the “combined feedback”. The wireless multicast can be delivery targeted to regionally or locally grouped end user sub-populations to enhance the overall network efficiency. This process repeats in a continuous fashion, with continuous N+1 events of “combined feedback” delivered to the software application, which in turn modifies the streamed forward path content.

The Forward Path Multi-Media Management System in general relates to any application that has at least one end user but preferably a plurality of end users wherein each end user has periodic reverse path feedback content coupled with a bandwidth intensive forward path data stream from a central source that can concurrently wirelessly deliver the given data stream to all respective sub-populations, each having their own multicast, and in aggregate the Forward Path Multi-Media Management System serves the entire population (thereby realizing substantial networking efficiencies). The number of applications that fit this set of networking attributes is virtually limitless. This is described in substantially more detail in the following figures and specification where the interrelationships and interconnections are examined.

End users in the Network For Multi-Media Management can be grouped via location or region, together with personal attributes such as demographic, socio-graphic, or psychographic interests as it relates to a given multicasted content stream. The pairing of physical location groupings with personal interest attributes enables new and novel telecommunication services with the attendant advantage of extremely efficient delivery. The wireless communication network's capacity utilization, both in terms of assets and spectrum, is very high.

In the Network For Multi-Media Management architecture, the reverse path (end user to network direction) can be wired or wireless. Thus, the reverse path has flexibility in terms of its connectivity as well as the relative speed of its connection. For instance, a computer connected to a home or office LAN can use their personal LAN network for reverse path connectivity to the Forward Path Multi-Media Management System. However, to realize the forward path efficiencies of concurrent delivery of the streamed content, the computer also has the ability to wirelessly receive the concurrent forward path for its sub-population geographic grouping via cellular, WiFi, WiMax, MediaFLO, DVB-H, or some other wireless means. Alternatively, if the reverse path is wireless only, the end user device could use the same network as the forward path stream, such as in a WiFi or WiMax network; or it could be a hybrid of WiFi or cellular in the reverse path and MediaFLO in the forward path. The end user device could be a PC, a PDA, a cell phone, or some specialized device like a video game controller. Thus, the Network For Multi-Media Management architecture is not limited to any one configuration.

The Network For Multi-Media Management solves a complex problem resident in existing telecommunication architectures by combining reverse path feedback with forward path multicasting in numerous novel ways to achieve high delivery efficiency, high subscriber targeting, and continuous content modification ensuring high relevancy.

### BRIEF DESCRIPTION OF THE DRAWINGS

FIGS. 1A and 1B illustrate, in block diagram form, the conceptual architecture of a typical Communication Network For A Forward Path Multi-Media Management System;

FIG. 1C illustrates a wireless network implementation of the present Communication Network For A Forward Path Multi-Media Management System;

FIG. 2 illustrates, in flow diagram form, the macro process steps that the Forward Path Multi-Media Management System takes to complete a continuous forward path modification cycle; and

FIG. 3 illustrates, in block diagram form, an alternative wireless communication network implementation of the present Communication Network For A Forward Path Multi-Media Management System using a typical broadcast network and its associated cellular communication network.

### DETAILED DESCRIPTION OF THE INVENTION

### Forward Path Multi-Media Management Philosophy

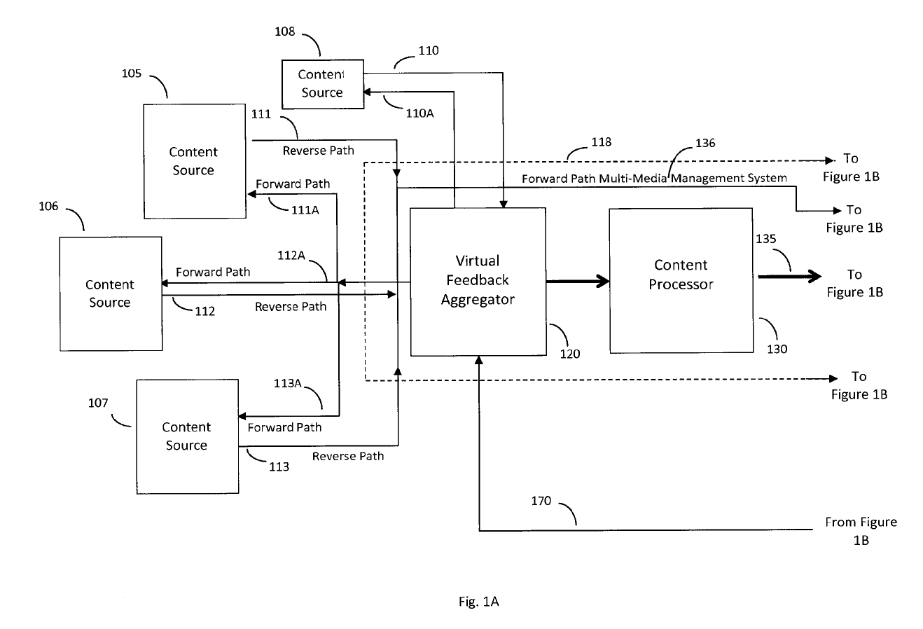

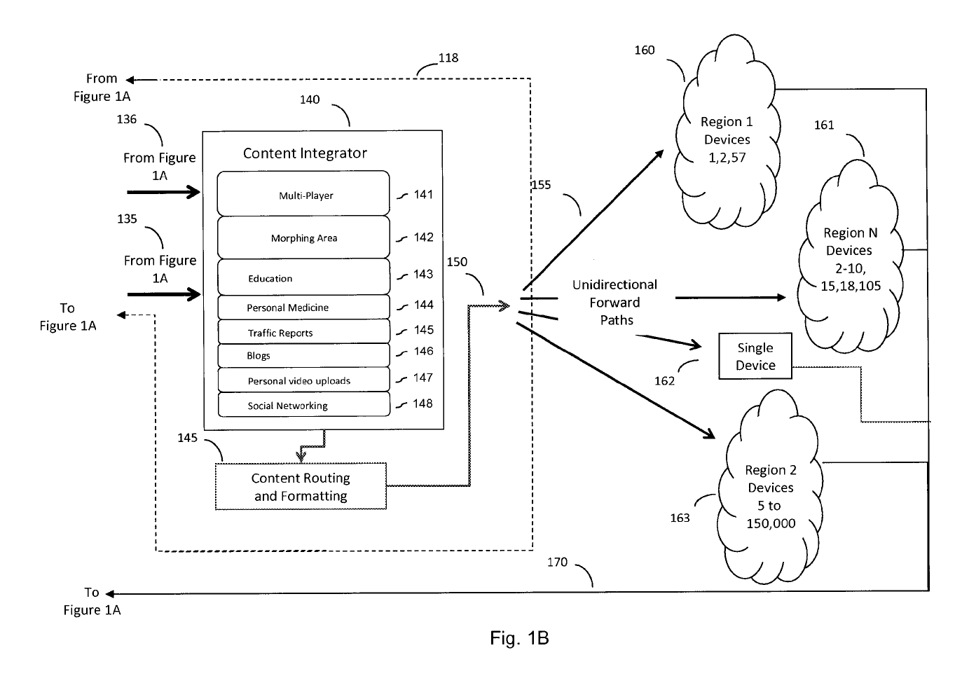

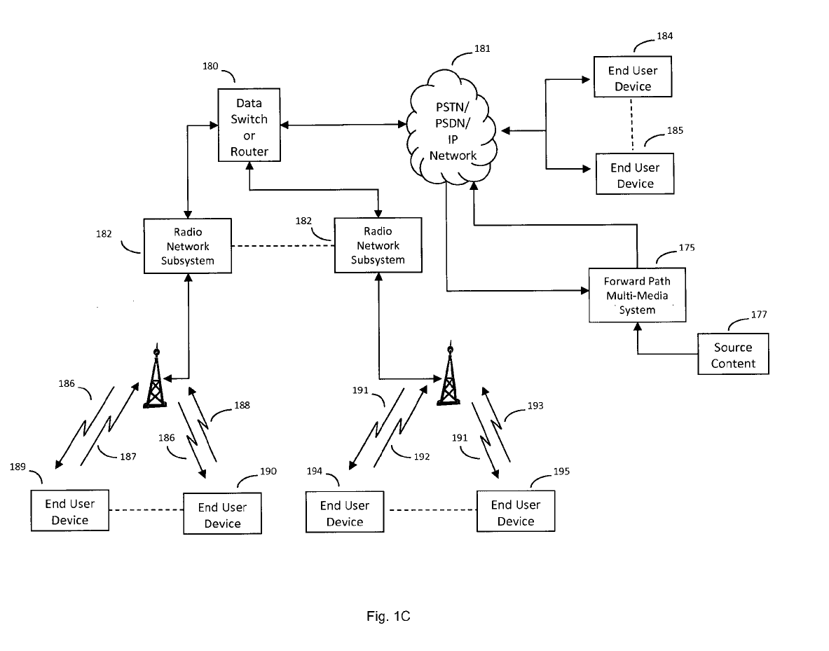

FIGS. 1A and 1B illustrate, in block diagram form, the conceptual architecture of a typical Communication Network For A Forward Path Multi-Media Management System. FIGS. 1A and 1B depict a logical or functional description of the Forward Path Multi-Media Management System architecture and show the essential building blocks of the overall system.

Content sources 105-107 are centrally located and are typically sources of broadband multi-media programs that are either generated off-line or dynamically generated on-line. The content could be visual or visual/aural in its extent, or it could take some other form such as machine-to-machine data. This content is of interest to one or more grouped sets of end users (subscribers) on the forward path multicast.

End user devices that receive the content can be grouped by region, locale, or geography as sub-populations 160-163, where sub-population 163 is the Nth sub-population. In aggregate, all of the sub-populations form the “population” of end users. While not shown, these sub-populations could also be formed on the basis of end user attributes such as demographic, psychographic, or socio-graphic attributes; thus, the grouping may be logical and not physical. With this type of attribute matching, the grouping takes the form of a logical group versus a physical group and can be characterized also as a sub-population or population. The attribute grouping could also be paired with a physical grouping such that end users can be both logically and physically grouped to form a multicast sub-population.

The grouping process, be it geographic-, attribute-, or combinatorially-based, is accomplished via methods well understood in the art. To realize geographic grouping, the GPS position can be mapped to a given radii, and all end users within that radii are grouped. For attribute grouping, the end user or subscriber attributes are stored in a database such as a Home Location Register (HLR) if the wireless network is cellular; then all end users with the requisite attributes are logically joined as a group independent of their physical location. Alternatively, both “grouping” methods, geographic and logical attribute, are combined to provide highly targeted delivery, both by location and by needs. Other grouping methodologies are possible, and nothing herein limits how groups are formed. The groups that are defined are used by content routing and formatting element 145 shown on FIG. 1B to activate the network to deliver a particular stream of content to the grouped end user devices and in a format that matches their particular display and function characteristics.

Forward Path Multi-Media Management System 118 includes three building blocks: Virtual Feedback Aggregator 120 acts as a communication device and buffer to collect and aggregate all of the reverse path information; Content Processor 130 acts as an information processor where software applications reside and process various input from the connected end user devices; and Content Integrator 140 performs the functionality of modifying the selected multimedia content stream. The modification by Content Integrator 140 could be a video frame processor, an audio stream modifier, or both, for example.

Content Processor 130 has algorithms to determine how N reverse path modifier inputs should be collectively assimilated and then sent to Content Integrator 140 for content modification. Content Processor 130 determines how to apply the collective inputs for a given processing step performed in Content Integrator 140. There is at least one resident software application, and there could be multiple software applications concurrently operating. The input includes, but is not limited to: what region an end user device is in (useful for forming the forward path multicast region); what sensor data is the device sending, such as HazMat information; what is the GPS location of a given device; is there a “user input” such as an action or motion for a gaming application, and so on.

Reverse path 170 originating in FIG. 1B and connected to Forward Path Multi-Media Management System 118 and internally to Virtual Feedback Aggregator 120 provides a feedback link whereby end user devices in groupings 160, 161, 162, and 163 communicate data for the content modification procedure that ultimately occurs at Content Integrator 140. This completes a continuous processing cycle end-to-end across the Forward Path Multi-Media Management System 118.

The Forward Path Multi-Media Management System 118 enables the functions of aggregation of reverse path content at Virtual Feedback Aggregator 120. The reverse path content conveyed from content sources 105-108 is comprised of content that is multi-media in nature, where the content sources 105-108 are uploading raw content to the Content Integrator 140 of the Forward Path Multi-Media Management System 118.

It is anticipated that the preferred embodiment has a feedback loop comprising reverse path 170 as the content modification data link, and paths 110, 111, 112, and 113 are used primarily for content source paths. In addition, the forward path components 110A-113A, where links 110-114 are bidirectional links, are shown as directly connected to the content sources 105-108 to illustrate how the forward path multi-media content can be modified directly at the content generating content sources 105-108. In this architecture, the content sources 105-108 embody a content processing capability similar to the Forward Path Multi-Media Management System 118.

At Content Integrator 140, the processing steps for a gaming application are different than the processing steps for a HazMat event, for example. Content Integrator 140 can have a number of applications, and the listed applications in no manner suggest that this is the entire set of applications that the Forward Path Multi-Media Management System is capable of implementing. In addition, the applications illustrated herein can be implemented as an integral part of the Forward Path Multi-Media Management System 118, or can be sites that are located external to the Forward Path Multi-Media Management System 118. These external sites can be existing content generating and processing systems, such as a massively multiplayer role-playing game (MMORPG) which enables players located at diverse locations to form sub-groups, tribes, or armies within the game space.

The applications illustrated in the Forward Path Multi-Media Management System 118 are for illustration, and multi-player application 141 is a gaming process that implements multi-player gaming or live multi-party interactive competitions. Morphing Area process 142 uses the received reverse path feedback data to map a geographical locus and region of a physical phenomenon that is detected by a plurality of the end user devices, such as the presence of a BioHazard. Education application 143 represents an education application where a student or students can ask professors questions of a live multicasted classroom lecture. Personal Medicine application 144 is a multi-party medical feature, such as a support group for cancer. Traffic reporting application 145 uses the feedback received from the end user devices to map road conditions on the various highways that are being traversed by the end users. Blogging application 146 provides the end users with a venue to post blogs. Personal video upload service 147 enables the end users to upload multi-media files for sharing among end users. Social networking application 148 represents any multi-party communication site.

The output of these various services and applications are transmitted to content routing and formatting element 145 for display formatting and routing to end user groups. These outputs then are transmitted via communication path 150 to effect a multicast of the modified content which is transmitted to the end user devices via the forward path 155 of the communication network. Note that forward path 155 can take on many forms, ranging from cellular to MediaFLO to WiMax, and this listing does not limit the inclusion of other means which realizes a simultaneous forward path delivery mode. Forward path 155 connects to end user groupings 160, 161, 163, and to end-user device 162. As an example, grouping 160 contains end user devices 1, 2, and 57 which are unique to Region 1; the forward path to this grouping could be via MediaFLO, for example. In grouping 161, Region N's end user devices 2-10 and 15, 18, and 105 might be connected via forward path 155 as a WiFi architecture. In Region 2, the listed end user devices could be connected via forward path 155 as a DVB-H signal. The Single Device 162 may be in a very remote area, so it uses a mobile satellite to receive forward path 155.

### Process or Modifying the Forward Path

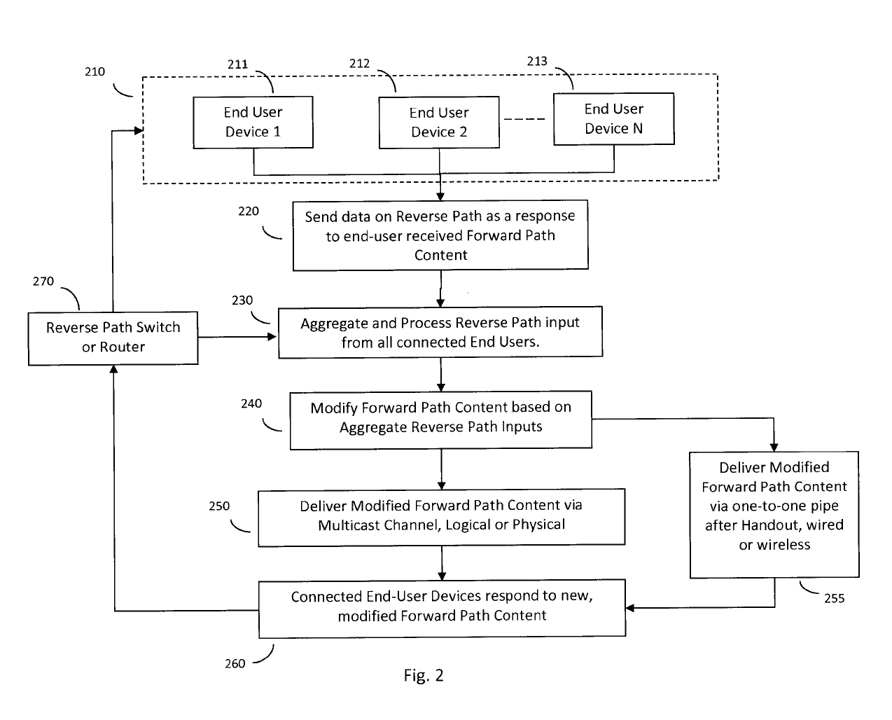

In FIG. 2, a typical process for modifying the content that is transmitted on the forward path is described. This is merely one of a number of methods to modify the content that is transmitted on the forward path and is not meant to be the only means for such forward path modification.

At step 210, the entire population of then connected end user devices is shown. The Network For Multi-Media Management is not limited to where the end user devices are physically located. End User Device 1 (211), along with End User Device 2 (212) and End User Device “N” (213), respond to the most recent forward path content, such as the display on a hand-held video game, and initiate a reverse path communication via their end user device at step 220, such as how to move their avatar in an action game. At step 230, the Forward Path Multi-Media Management System receives and processes the reverse path input from the then connected end user devices.

At step 240, the forward path content, still to be delivered back to the connected end user population, is modified. Thus, in this gaming application, the next frame (or number of frames) of the game is modified based on the collectively aggregated reverse path input. At step 250, the game video and audio is delivered via a shared forward path. The delivery can be via physical grouping, logical grouping, or a combination of the two forms of grouping. At step 255, the game video and audio is delivered via a one-to-one communication means, either wired or wireless.

At step 260, the feedback loop starts again where the end users via their end user devices begin to respond to the new video and audio being displayed on their end user devices. Step 260 connects to step 230 in a continuous fashion until the game is complete or some other decision for game termination is realized, such as a time or date. In addition, at step 270, the end user feedback can be destined for selected ones of the other players in the multi-player game so a player can team with other players in a personal end user device-to-end user device communication link over the bidirectional links.

### Cellular Network Implementation

FIG. 1C illustrates one embodiment of the present Communication Network For A Forward Path Multi-Media Management System. In FIG. 1C, a cellular network is depicted, but other network architectures are capable of realizing Forward Path Multi-Media Management System functionality. Other network types include: MediaFLO, WiFi, WiMax, satellite, Bluetooth, UWB, and so on. Of note, certain cellular building blocks are not shown for concept clarity; the devices not shown include, but are not limited to: Home Location Register (HLR), Visitor Location Register (VLR), Mobile Switching Center (MSC), Packet Data Switch Network (PDSN), and so on. The function and interconnection of these devices is well known in the art.

Radio Network Sub-System 182 and Radio Network Sub-System 183 are shown, and these Radio Network Sub-Systems could be CDMA or TDMA for their RF access protocol; they could be 3G or 3.5G in their deployment lifecycle. The frequencies could be 800 MHz or 2 GHz. Each Radio Network Sub-System serves a unique geographic region. Cell site 198 serves end user devices 189 through 190, and cell site 199 serves end user devices 194 through 195.

Cell site 198 could be omni-directional in its coverage extent, while cell site 199 could be sectorized in its coverage. Further, end user devices 189-190 are grouped together because they are receiving a common multicast from Radio Network Sub-System 182 via cell site 198 along RF forward path 186 Likewise, end user devices 194-195 are receiving a common multicast from sectorized cell site 199 via RF forward path 191. However, on the reverse RF path, end user device 189 communicates via RF pathway 187, while end user device 190 communicates on the reverse path via RF pathway 188; and end user device 194 communicates on reverse path 192, while end user device 195 communicates via reverse path 191.

In a process well understood in the art, a mobile device (end user device) could move from sectorized cell site 199 to omni-directional cell site 198 and retain seamless coverage via the hand-off or hand-over process. Hand-offs can be hard, meaning the previous signal is dropped before the new signal is acquired, or they can be soft, where both cell sites 198 and 199 would have communication for a period of time until the hand-off is completed. Separately, within the sectored cell site 199, a “softer” hand-off process can occur wherein the end user device operates on two adjacent coverage sectors of cell site 199 at the same time.

To initiate a forward path modification sequence, a content modification signal is sent across the physical network. Tracing the path of one example reverse path signal, end user device 189 would communicate via reverse path 187 to cell site 198, which then communicates with Radio Network Sub-System 182. Radio Network Sub-System 182 then communicates with data switch/router 180 to the network 181. Network 181 contains all the typical networking formats to include Public Telephone Switched Network (PSTN), Public Switched Data Network (PSDN), and an Internet Protocol Network (IP Network). In addition, while not shown, other protocols that are more suited to a mobile architecture, such as IPv6, may be deployed.

The network 181 is connected to end user devices 184 and 185 via a more traditional wired paradigm. Forward Path Multi-Media Management System 175 is connected to network 181, and Forward Path Multi-Media Management System 175 receives reverse path modification information from all the then connected end user devices and processes the data in a manner described herein. The Source Content site 177 delivers content to Forward Path Multi-Media Management System 175; content can be multi-media or any other data form that has relevance to the subscriber population or sub-population. After the Forward Path Multi-Media Management System has performed its operations, it forwards the modified forward path content back to network 181. Network 181 then communicates to router 180, then radio network subsystem 182 and cell site 198 finally transmit the modified forward path content via RF path 186 to end user devices 189-190, respectively. This process repeats in a cyclical fashion, starting with reverse path modification information to the Forward Path Multi-Media Management System 175, which then modifies the forward path content, on a frame-by-frame basis if video, and then back to the end user devices.

### Reverse Path Transaction Management System in a Broadcast Architecture

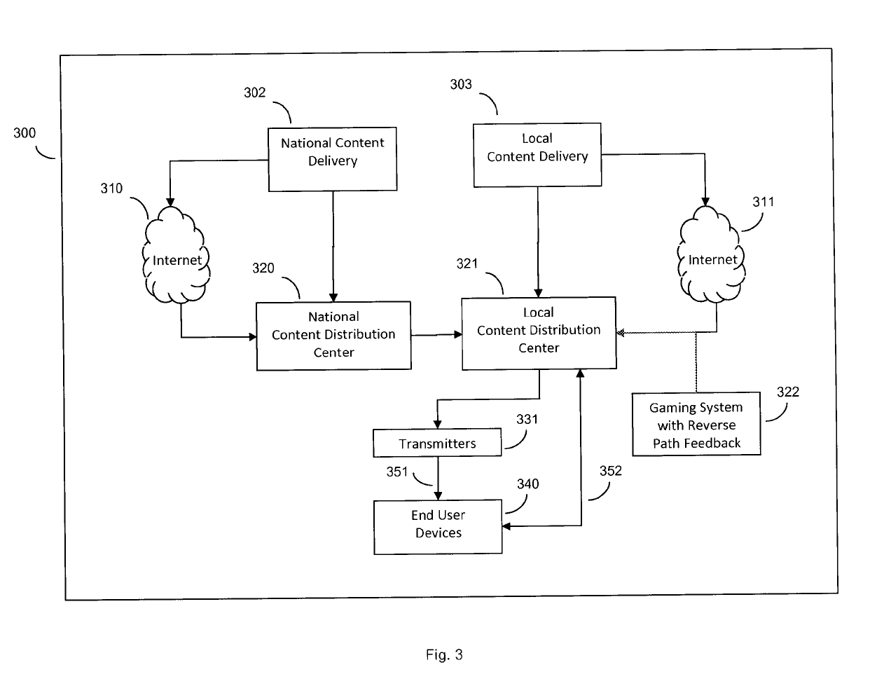

New multi-media wireless delivery architectures such as MediaFLO (Qualcomm trademark—“Media ForwardLinkOnly”) and DVB-H (Digital Video Broadcast-Handheld) use a broadcast architecture to distribute multi-media content to subscribers in a predefined service area. FIG. 3 illustrates, in block diagram form, the overall architecture of a typical broadcast network 300 and its associated cellular communication network 110 that is equipped with the present Reverse Path Transaction Management System 114. The cellular communication network 110 has an architecture and operation as that described with respect to FIGS. 1A and 1B, so like elements in FIGS. 1A, 1B, and 3 are labeled identically.

These broadcast network architectures rely on the presence and use of an associated cellular communication network 110 to provide the subscriber authentication and authorization functions to enable a subscriber to access the multi-media content being transmitted over the broadcast network 300. In these network architectures, a unidirectional multi-media broadcast network 300 transmits multi-media content 303 to wireless subscriber devices 101, 102 independent of the cellular communication network 110 that is operational in the same coverage area. The wireless subscriber devices 101, 102 used in these broadcast network architectures contain a multi-media content broadcast receiver which does not have the capability to communicate in a “reverse path” direction over the broadcast network 300. That is, the MediaFLO and DVB-H multi-media content broadcast receivers are incapable of transmitting anything, much less processing a “transaction”. In the case of MediaFLO, for example, the wireless subscriber device 101, 102 is often a dual mode device which contains both a forward-path only MediaFLO broadcast receiver for receiving the broadcasted multi-media content (television) 303 as well as a conventional CDMA or GSM cell phone for cellular telephone calls. However, there is no “connectivity” between these essentially two disparate devices housed within a single wireless subscriber device, and the two networks with which they interact are operationally independent. The MediaFLO broadcast receiver cannot communicate with the imbedded cell phone, and the imbedded cell phone cannot communicate with the MediaFLO device during the receipt of the multi-media content.

In operation, as shown in FIG. 3, the multi-media content is delivered to a multi-mode subscriber device 101, 102 via radio frequency transmissions 303 which are broadcast in a predefined coverage area via broadcast transmitters 302. The multi-media content typically is encoded or encrypted to prevent non-subscribers from receiving the multi-media content. The subscriber, therefore, initiates receipt of the broadcast encoded multi-media content 303 by activating the multi-mode subscriber device 101, 102 to access the carrier's operations center 304. This communication typically is effected via the cellular telephone in the multi-mode subscriber device 101, 102, which is used to transmit a registration request to the carrier's operations center 304. The request is processed by the carrier to identify and authenticate the subscriber multi-mode device, verify the authorization of this subscriber to receive the requested service, and return a decryption key to the subscriber multi-mode device 101, 102 to enable it to decrypt the multi-media content 303 that is being broadcast. The broadcast receiver of the multi-mode subscriber device 101, 102 receives the encoded multi-media transmissions 303 and uses the decryption key that was received from the carrier operations center 304 to convert the received encrypted multi-media content into its native format and deliver the multi-media content to the subscriber.

FIG. 3 illustrates an implementation of the present Communication Network For A Forward Path Multi-Media Management System using this broadcast network and its associated cellular communication network. This network 300 comprises a wireless multicast network using a unidirectional high bandwidth forward path 351 to transmit content to selected groups of end users (such as end user 340), as well as bidirectional links 352 which connect the end user devices 340 with a content distribution site 321. The content can be generated by end user devices as noted above, or obtained from various sources, such as national content provider 301, 302, local content provider 303, 304 which typically use various communication media, such as Internet 310, 311, to deliver content to national content distribution center 320, and local content distribution center 321 for forwarding to transmitters 331, 332, which wirelessly broadcast the content via unidirectional forward path 351 to the selected end user devices 340.

In this architecture, the selected end user devices have two communication links with the local distribution center 321: the unidirectional forward path 351 which is a broadcast format transmission, and the bidirectional link 352 which has a reverse path component for transmitting end user feedback from the selected end user devices to the local content distribution center 321, as well as a forward path component for transmitting end user private data from the local content distribution center 321 to an individual end user device. Thus, each end user device can communicate private information to and from the local content distribution center 321 via the reverse path and forward path components, respectively, of the bidirectional link 352. In addition, private data can also be transmitted to the end user device via the unidirectional forward path 351 as an in-band encrypted data stream, which only the one end user device can decrypt using their personal decryption key. Thus, multiple private data transmissions can be included in the unidirectional forward path 351 transmission if they are time-interleaved and encrypted.

The Forward Path Multi-Media Management System 322 can be located at various sites within this network 300 and, for the sake of illustration, is shown as being connected to the local content distribution center 321. Since many of the massively multi-player role-playing games are national or even international in scope, the site of the Forward Path Multi-Media Management System 322 is more a choice among a number of variables including, but not limited to: available network bandwidth, base location of the company hosting the massive multi-player role-playing game, and the like. The Forward Path Multi-Media Management System 322 also can be located within the local content distribution center 321 or the national content distribution center 320 as a matter of choice. The communications between the local content distribution center 321 and the Forward Path Multi-Media Management System 322 in this example carry the content to the Forward Path Multi-Media Management System 322 from the various content sources, such as content sources 302, 303. In addition, content and modified content from the Forward Path Multi-Media Management System 322 to the end user devices is carried over the forward path 352, and feedback from the end user devices to the Forward Path Multi-Media Management System 322 is carried over the bidirectional links 352, as is the private data from the Forward Path Multi-Media Management System 322 to the end user devices. Thus, the local content distribution center 321 is an intermediate data transmission element interposed between the Forward Path Multi-Media Management System 322 and the end user devices.

### SUMMARY

The present Network For Multi-Media Management enables a reverse path feedback architecture wherein the forward path multicasted content can be dynamically modified as a result of end user interaction or feedback.

1. A Network For Multi-Media Management, which wirelessly delivers content over a communication network to a plurality of wireless end user devices, comprising:
at least one unidirectional forward broadcast path that extends from said communication network to said wireless end user devices for transmitting content received at said communication network from a multi-media manager concurrently to a selected plurality of said wireless end user devices; and
at least one private reverse path from said selected plurality of wireless end user devices to said communication network for transmitting end user feedback data from at least one of said selected wireless end user devices to said multi-media manager to dynamically modify said content delivered by said multi-media manager concurrently to said selected wireless end user devices.

2. The Network For Multi-Media Management of claim 1 further comprising:
a private forward path that extends from said communication network to said wireless end user devices for delivering private end user specific data from said multi-media manager to a selected wireless end user device.

3. The Network For Multi-Media Management of claim 2 further comprising:
routing means, responsive to receipt of routing instructions from said selected wireless end user device over said private reverse path, for forwarding said end user specific data to at least one other of said wireless end user devices.

4. The Network For Multi-Media Management of claim 3 further comprising:
private data means for transmitting said end user specific private data received at said routing means to said at least one selected wireless end user device over a corresponding private forward path.

5. The Network For Multi-Media Management of claim 2 wherein said private forward path comprises:
in-band means for transmitting encrypted data to said selected wireless end user device via an in-band transmission in said unidirectional forward broadcast path.

6. A method of operating a Network For Multi-Media Management, which wirelessly delivers content over a communication network to a plurality of wireless end user devices, comprising:
transmitting, over at least one unidirectional forward broadcast path that extends from said communication network to said wireless end user devices, content received at said communication network from a multi-media manager concurrently to a selected plurality of said wireless end user devices; and
transmitting, over at least one private reverse path from said wireless end user devices to said communication network, end user feedback data from at least one of said selected wireless end user devices to said multi-media manager to dynamically modify said content delivered by said multi-media manager concurrently to said selected wireless end user devices.

7. The method of claim 6 further comprising:
delivering, over a private forward path that extends from said communication network to said wireless end user devices, private end user specific data from said multi-media manager to a selected wireless end user device.

8. The method of claim 7 further comprising:
forwarding, in response to receipt of routing instructions from said selected wireless end user device over said private reverse path, said end user specific data to at least one other of said wireless end user devices.

9. The method of claim 8 further comprising:
transmitting said wireless end user specific private data to said at least one selected wireless end user device over a corresponding private forward path.

10. The method of claim 7 further comprising:
transmitting encrypted data to said selected wireless end user device via an in-band transmission in said unidirectional forward broadcast path.
